(19) United States
(12) Patent Application Publication
(10) Pub. No.: US 2007/0160784 A1
(43) Pub. Date: Jul. 12, 2007

(54) Structure design of scratch and abrasion resistant film

(75) Inventor: Kuen-Chi Hung, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/329,112

(22) Filed: Jan. 11, 2006

(51) Int. Cl. F16B 4/00

(52) U.S. Cl. 428/34.9; 428/43

(57) ABSTRACT

The present invention is to provide a structural design for a scratch and abrasion resistant film, which is a heat-shrink film having a plurality of predetermined positioning contour lines and holes disposed thereon in accordance with the contour corners of a case and the external parts, such as buttons, antenna, etc., of a communication device so that when the communication device is sleeved in the heat-shrink film and the heat-shrink film is heated to shrink, by means of those positioning contour lines and positioning holes maintaining the alignment with the corresponding contour corners and the external parts on the case, the heat-shrink film is shrunken to the right positions to smoothly cover the case, serving as a protection layer for the case against being directly scratched and attaining the scratch and abrasion resistant purpose.

### FIELD OF THE INVENTION

The present invention relates to a scratch and abrasion resistant film, and more particularly to a structural design for a scratch and abrasion resistant film capable of being heated to shrink to the right positions to smoothly cover a case of a communication device and serving as a protection layer for the case against being directly scratched.

### BACKGROUND OF THE INVENTION

Nowadays, the global technology changes with each passing day. More and more delicate electronic products have been vastly utilized to further improve the life quality of mankind. The advent of the mobile phone brings about more comfort and convenience into personal life. While the function of mobile phone is getting more powerful and the size is getting smaller, industry and consumer have the increasing demand toward the appearance of mobile phone. Currently, the case of mobile phone is mainly composed of plastic material for sake of the concern of cost saving and light weight. However, the plastic material has low hardness that is apt to be scratched. As a result, after being used for a while, mobile phone tends to leave trace or peeling paint arising from scratch and abrasion.

As a consequence, mobile phone manufacturers designed a mobile phone with the swappable case so that user can always have new case with different pattern in place. Such move not only makes mobile phone more personalized, but also keeps mobile phone like a brand new one, making user feel satisfied constantly. Whereas, such mobile phone with the swappable case gives rise to the additional cost out of each case and the considerable used cases easily cause overrun garbage and environmental protection issues. Therefore, how to design a scratch and abrasion resistant film to solve the mentioned issues, protect mobile phone and provide personalized style, is a subject on top of the list to be immediately tackled.

### SUMMARY OF THE INVENTION

In view of the shortcomings while practically utilizing the aforementioned mobile phone, the inventor, based on years of technical experience and accumulated professional knowledge, targets at the mentioned issues in an attempt to develop a structural design for the scratch and abrasion resistant film of the present invention.

In accordance with the first aspect of the invention, a structural design for a scratch and abrasion resistant film is provided. The provided scratch and abrasion resistant film is a heat-shrink film having a plurality of predetermined positioning contour lines disposed thereon in accordance with the contour corners of a case of a communication device, a plurality of predetermined positioning holes disposed in accordance with the external parts, such as button, antenna, etc., of the communication device so that when the communication device is sleeved in the heat-shrink film and the heat-shrink film is heated to shrink, by means of those positioning contour lines and positioning holes maintaining the alignment with the corresponding contour corners and the external parts on the case, the heat-shrink film is shrunken to the right positions to smoothly cover the case, serving as a protection layer for the case against being directly scratched and attaining the scratch and abrasion resistant purpose.

In accordance with the second aspect of the invention, at least a decoration part is provided. The decoration part disposed on and/or beneath the heat-shrink film has an animal pattern, a plant pattern, a numerical pattern or a geometric figure. When the communication device is covered by the heat-shrink film, the pattern design of the decoration part can be shown on the communication device, providing the communication device a more striking appearance and a more personalized style.

The above and other objects, features and advantages of the present invention will become apparent from the following detailed description taken with the accompanying drawings.

### BRIEF DESCRIPTION OF THE DRAWINGS

FIG. 1 is an exploded view showing the heat-shrink film and the communication device of the present invention;

FIG. 2 is a 3D exploded view showing another side in FIG. 1; and

FIG. 3 is a schematic view showing the 3D assembly in FIG. 1.

### DETAILED DESCRIPTION OF THE PREFERRED EMBODIMENTS

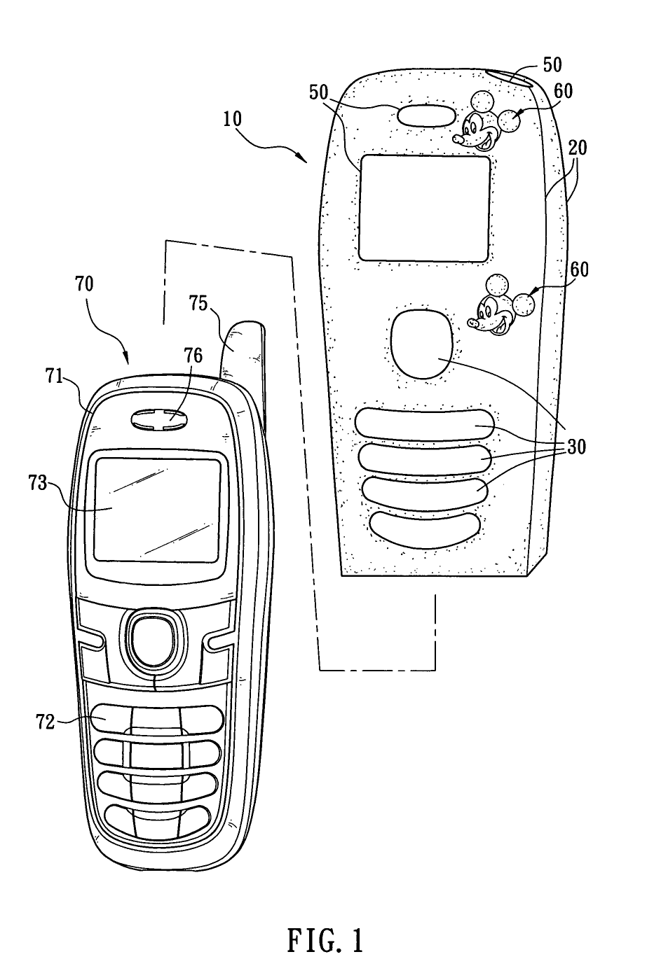

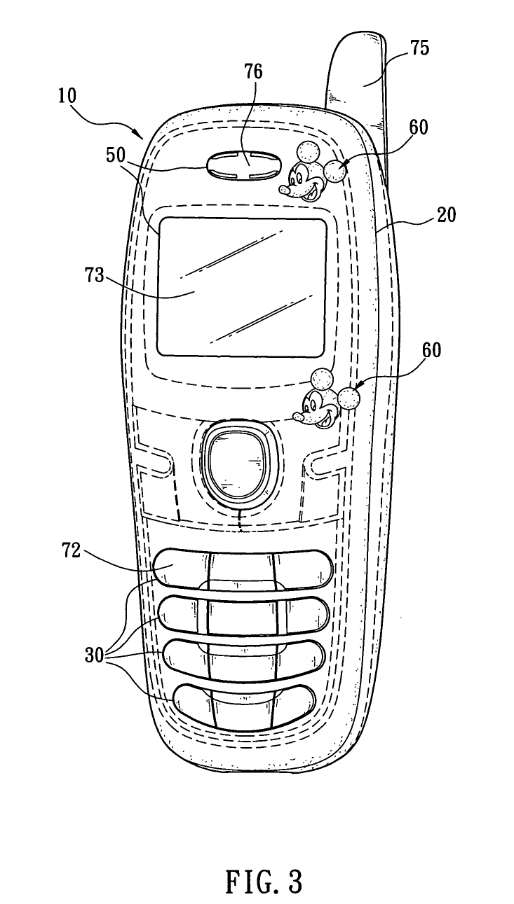

The invention relates to a structural design of a scratch and abrasion resistant film. Please refer to a preferred embodiment shown in FIG. 1 including a heat-shrink film 10. The structural design of the heat-shrink film 10 is designed to target at a communication device 70 (e.g. mobile phone) so as to match the external structure of the case 71 of the communication device 70. The heat-shrink film 10 is disposed at least a positioning contour line 20 and a positioning hole 30 in advance. Each positioning contour line 20 corresponding to a contour corner on the case 71, and each positioning hole 30 corresponding to the external part, such as a screen, a button and an antenna, are disposed on the communication device 70. Therefore, after the user of the heat-shrink film puts the communication device 70 in the heat-shrink film 10, the positioning line 20 and the positioning hole 30 align with the corresponding contour corner and the external part on the case 71 respectively. Then the heat-shrink film 10 is heated to diminish gradually. While the heat-shrink film 10 is getting dwindled, each positioning hole 30 and positioning contour line 20 still align with the corresponding contour corner and external part on the case 71. Consequently, as shown in FIG. 3, the heat-shrink film 10 can be gradually shrunken at the right position to smoothly cover the case 71 and provide a protection layer for the case 71, preventing the case from being directly scratched and attaining the scratch and abrasion resistant purpose.

Please refer to FIG. 1 again. A decoration part 60 is disposed on and/or beneath the heat-shrink film 10. The decoration part is a pattern design in form of an animal figure, a plant figure, a numerical modeling or a geometric figure. As such, after the case 71 of the communication device 70 is covered by the heat-shrink film 10, the pattern design of the decoration part 60 is shown on the communication device 70, making the appearance of the communication device 70 more striking and having a more personalized style.

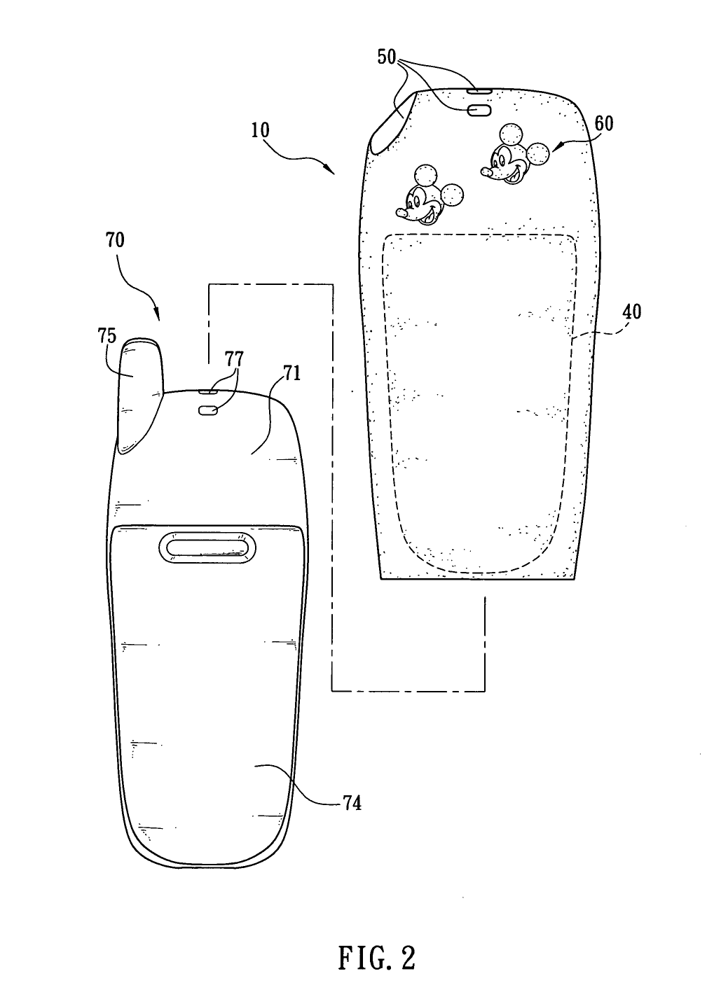

Please refer to FIG. 2 showing another preferred embodiment of the present invention. There is a tear-off line 40 disposed on the heat-shrink film 10. The tear-off line 40 is designed to extend along the perimeter of a battery 74 of the communication device 70. After the case 71 is smoothly covered by the heat-shrink film 10, by means of ripping off the tear-off line 40, the portion of the heat-shrink film 10 corresponding to the battery 74 is removed to facilitate the later replacement of the battery 74.

Moreover, please refer to FIG. 1 and FIG. 2 again. An opening is disposed on the heat-shrink film 10 corresponding to the screen 73, the speaker 76 or the ornament hole 77 of the communication device 70. After the case 71 is smoothly covered by the heat-shrink film 10, the opening 50 exactly aligns with the screen 73 or the speaker 76 so that the screen 73 can be clearly shown without affecting the voice made by the speaker 76 or the general ornament is enabled to be coupled with the ornament hole 77. Besides, the positioning contour line 20 of the heat-shrink film 10 and the rim of the positioning hole 30 and the opening 30 can be pre-heated to diminish while producing the heat-shrink film 10, ensuring that the positioning contour line 20, the positioning hole 30 and the opening 50 won't be dwindled again due to heating. Consequently, when the communication device 70 is enveloped in the corresponding heat-shrink film 10 and heated once again, the positioning contour line 20, the positioning hole 30 and the opening 50 can be aligned to the contour corner and the external part on the case 71 more steadily.

While the invention herein disclosed has been described by means of specific embodiments, numerous modifications and variations could be made thereto by those skilled in the art without departing from the scope and spirit of the invention set forth in the claims.

What is claimed is:

1. A structural design of a scratch and abrasion resistant film having a heat-shrink film and designed for a case of a communication device, wherein said heat-shrink film comprises:
at least a positioning contour line corresponding to a contour corner of said case; and
at least a positioning hole corresponding to an external part pertinent to a screen, a button or an antenna on said communication device.

2. The structural design of a scratch and abrasion resistant film of claim 1, wherein a decoration part is disposed on or under said heat-shrink film.

3. The structural design of a scratch and abrasion resistant film of claim 2, wherein said decoration part is a pattern design in form of an animal figure, a plant figure, a numerical modeling or a geometric figure.

4. The structural design of a scratch and abrasion resistant film of claim 1, wherein a tear-off line is disposed on a position of said heat-shrink film corresponding to a battery of said communication device.

5. The structural design of a scratch and abrasion resistant film of claim 1, wherein at least an opening corresponding to a screen or an ornament hole of said communication device is disposed on the heat-shrink film.

6. The structural design of a scratch and abrasion resistant film of claim 1, wherein said positioning contour line and a rim of said positioning hole are preheated to get diminished upon manufacturing said heat-shrink film.
